(19) United States
(12) Patent Application Publication
(10) Pub. No.: US 2025/0278657 A1
(43) Pub. Date: Sep. 4, 2025

(54) INFORMATION PROCESSING DEVICE, CONTROL DEVICE, AND CONTROL METHOD

(71) Applicant: NEC Corporation, Tokyo (JP)

(72) Inventors: Aiko Yamaguchi, Tokyo (JP); Yuichiro Matsuzaki, Tsukuba-shi (JP)

(73) Assignee: NEC Corporation, Tokyo (JP)

(21) Appl. No.: 19/062,187

(22) Filed: Feb. 25, 2025

(30) Foreign Application Priority Data
Feb. 29, 2024 (JP) 2024-029419

(51) Int. Cl. G06N 10/40

(52) U.S. Cl. CPC G06N 10/40

(57) ABSTRACT

An information processing device includes a first Josephson parametric oscillator used as an information processing qubit element, a second Josephson parametric oscillator used as a readout qubit element, each configured with a Josephson parametric oscillator, and a coupler coupling the information processing qubit element and the readout qubit element, wherein a bit value indicated by the readout qubit element is same as a bit value indicated by the information processing qubit element.

### CROSS-REFERENCE TO RELATED APPLICATIONS

This application is based upon and claims the benefit of priority from Japanese patent application No. 2024-029419, filed on Feb. 29, 2024, the disclosure of which is incorporated herein in its entirety by reference.

### TECHNICAL FIELD

The present disclosure relates to an information processing device, a control device, and a control method.

### BACKGROUND ART

Information processing devices that use qubit devices, such as quantum annealing machines, have been proposed.

For example, Japanese Unexamined Patent Application, Publication No. 2021-132188 (Patent Document 1) discloses an information processing device that uses a nonlinear oscillator such as a Kerr parametric oscillator.

### SUMMARY

It is desirable to read out the bit value from the qubit device with the highest possible accuracy. In a case where the degree of freedom of control over a qubit device targeted for reading out bit values is high, it is expected that the control can be optimized for reading out bit values of the qubit device, allowing the bit values to be read out with relatively high accuracy.

An example of an object of the present disclosure is to provide an information processing device, a control device, an information processing system, and a control method capable of solving the problems mentioned above.

According to a first example aspect of the present disclosure, an information processing device includes an information processing qubit device and a readout qubit device, each configured with a Josephson parametric oscillator, and a coupler that couples the information processing qubit device and the readout qubit device. The readout qubit device is coupled by the coupler to the information processing qubit device so as to assume the same bit value as the information processing qubit device.

According to a second example aspect of the present disclosure, a control device includes a control means that controls an information processing device including an information processing qubit device and a readout qubit device, each configured with a Josephson parametric oscillator, and a coupler that couples the information processing qubit device and the readout qubit device, so that the readout qubit device is coupled by the coupler to the information processing qubit device so as to assume the same bit value as the information processing qubit device.

According to a third example aspect of the present disclosure, an information processing system includes an information processing device, and a control device. The information processing device includes an information processing qubit device and a readout qubit device, each configured with a Josephson parametric oscillator, and a coupler that couples the information processing qubit device and the readout qubit device. The control device includes a control means that controls the information processing device so that the readout qubit device is coupled by the coupler to the information processing qubit device so as to assume the same bit value as the information processing qubit device.

According to a fourth example aspect of the present disclosure, a control method includes a step, performed by a control device that controls an information processing device including an information processing qubit device and a readout qubit device, each configured with a Josephson parametric oscillator, and a coupler that couples the information processing qubit device and the readout qubit device, of controlling the information processing device so that the readout qubit device is coupled by the coupler to the information processing qubit device so as to assume the same bit value as the information processing qubit device.

### BRIEF DESCRIPTION OF THE DRAWINGS

FIG. 1 is a diagram showing a configuration example of an information processing system according to at least one of example embodiments.

FIG. 2 is a diagram showing a first example of the state of the output signal from a qubit device according to at least one of the example embodiments.

FIG. 3 is a diagram showing a second example of the state of the output signal from the qubit device according to at least one of the example embodiments.

FIG. 4 is a diagram showing a configuration example of a control device according to at least one of the example embodiments.

FIG. 5 is a diagram showing a first example of a combination of a computational qubit device and a readout qubit device according to at least one of the example embodiments.

FIG. 6 is a diagram showing a second example of a combination of the computational qubit device and the readout qubit device according to at least one of the example embodiments.

FIG. 7 is a diagram showing a third example of a combination of the computational qubit device and the readout qubit device according to at least one of the example embodiments.

FIG. 8 is a diagram showing an example of control timing for the computational qubit device and the readout qubit device according to at least one of the example embodiments.

FIG. 9 is a diagram showing an example of a processing procedure performed by the control device according to at least one of the example embodiments.

FIG. 10 is a diagram showing a first example of a configuration of an information processing device where an LHZ model is used, in at least one of the example embodiments.

FIG. 11 is a diagram showing a second example of a configuration of the information processing device where an LHZ model is used, in at least one of the example embodiments.

FIG. 12 is a diagram showing a configuration example of the information processing device according to at least one of the example embodiments.

FIG. 13 is a diagram showing an example of a configuration of the information processing device according to at least one of the example embodiments, where information processing qubit devices and readout qubit devices are denoted as qubit devices, explicitly exemplifying that the information processing device includes multiple qubit devices.

FIG. 14 is a diagram showing a configuration example of a control device according to at least one of the example embodiments.

FIG. 15 is a diagram showing a configuration example of an information processing system according to at least one of example embodiments.

FIG. 16 is a diagram showing a configuration of the information processing system according to at least one of the example embodiments, where information processing qubit devices and readout qubit devices are denoted as qubit devices, explicitly exemplifying that the information processing device includes multiple qubit devices.

FIG. 17 is a diagram showing an example of a processing procedure in a control method according to at least one of the example embodiments.

FIG. 18 is a diagram showing a configuration example of a computer according to at least one of the example embodiments.

### EXAMPLE EMBODIMENT

Hereinafter, example embodiments of the present disclosure will be described, however, the present disclosure within the scope of the claims is not limited by the following example embodiments. Furthermore, not all the combinations of features described in the example embodiments are essential for the solving means of the disclosure.

### First Example Embodiment

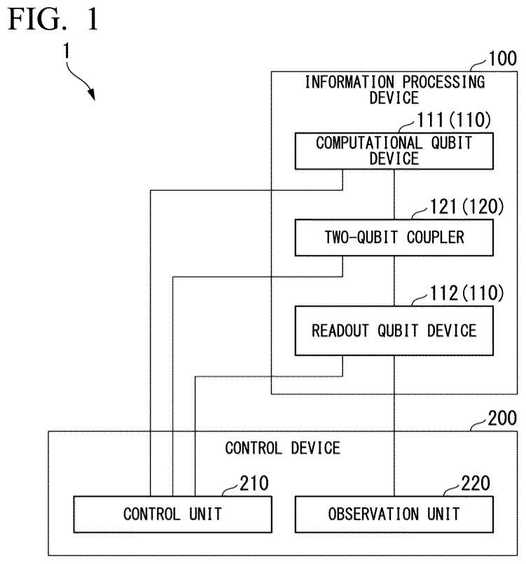

FIG. 1 is a diagram showing a configuration example of an information processing system according to at least one of example embodiments. In the configuration shown in FIG. 1, an information processing system 1 includes an information processing device 100 and a control device 200. The information processing device 100 includes multiple qubit devices 110 and a coupler 120. The control device 200 includes a control unit 210 and an observation unit 220.

The information processing device 100 uses the qubit devices 110 to perform computations.

The qubit device referred to here is hardware used to represent the value of a qubit (bit value). A Josephson Parametric Oscillator (JPO) may be employed as the qubit device 110.

The following describes an example in which the information processing system 1 performs quantum annealing. However, the computations performed by the information processing system 1 are not limited to those carried out using a specific method. For example, the information processing system 1 may be configured to function as a quantum gate computer.

The multiple qubit devices 110 included in the information processing device 100 include a computational qubit device 111 and a readout qubit device 112.

The computational qubit device 111 is a qubit device 110 that is used to perform computations by quantum annealing.

The readout qubit device 112 is provided to read out the bit value indicated by the computational qubit device 111. The readout qubit device 112 is not directly used in performing computations using quantum annealing. One readout qubit device 112 is controlled to indicate the same bit value as the bit value indicated by one computational qubit device 111.

The bit value indicated by a qubit device is also referred to as the bit value of the qubit device.

The condition where the readout qubit device 112 indicates the same bit value as the computational qubit device 111 is also referred to as the readout qubit device 112 indicating the same bit value as the computational qubit device 111.

Here, it is possible that control for quantum annealing may result in the computational qubit device 111 not being in a state appropriate for reading out the bit value. On the other hand, control distinct from that used for quantum annealing can be applied to the readout qubit device 112. In this regard, it is expected that the readout qubit device 112 can be controlled to achieve a state appropriate for reading out the bit value.

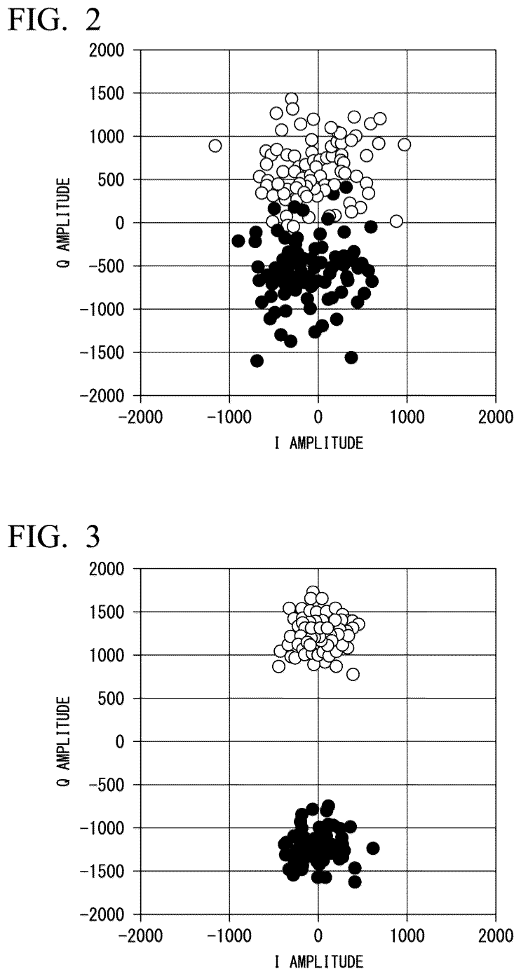

FIG. 2 is a diagram showing a first example of the state of the output signal from the qubit device 110. FIG. 2 is a diagram showing the output signal from the qubit device 110 in a case where the state of the qubit device 110 is not in a state appropriate for reading out the bit value, separated into an in-phase amplitude component and a quadrature-phase amplitude component.

The photon referred to here is a microwave photon that oscillates within the qubit device 110 and is also output from the qubit device 110.

The horizontal axis of the graph of FIG. 2 represents the in-phase amplitude (I amplitude), and the vertical axis represents the quadrature-phase amplitude (Q amplitude). In the graph of FIG. 2, the output signal from the qubit device 110 is measured multiple times, and points are plotted on the coordinate values of the in-phase amplitude (I amplitude) and quadrature-phase amplitude (Q amplitude) for each measurement.

In the graph of FIG. 2, the reference signal is set to a phase that is orthogonal to the oscillation output of the qubit device 110. The Q amplitude is shown as a positive value in the case where one of the two coherent states (referred to as first coherent state) is read. Also, the Q amplitude is shown as a negative value in the case where the second coherent state, which has a phase difference of II from the first coherent state, is read from the two coherent states that the qubit device 110 can take.

Moreover, in the graph of FIG. 2, the distance from the origin (radial distance) corresponds to the oscillation amplitude, and the deflection angle corresponds to the phase of the signal.

Additionally, the graph of FIG. 2 shows the results of numerical computations, with separate plots for the case where the correct answer is the first coherent state (white dots) and the case where the correct answer is the second coherent state (black dots).

In the example of FIG. 2, in a case where the photon count is small, the signal amplitude becomes smaller, and the Q amplitude decreases. Additionally, in a case where the noise is large, the uncertainty between the I amplitude and the Q amplitude increases. In the case where the noise is large relative to the signal amplitude, the distributions of the first coherent state and the second coherent state overlap, making it impossible to identify which coherent state it is in based on the I and Q amplitudes obtained from the measurement in the overlapping region.

FIG. 3 is a diagram showing a second example of the state of the output signal from the qubit device 110. FIG. 3 is a diagram showing the output signal from the qubit device 110 in a case where the state of the qubit device 110 is in a state more appropriate for reading out the bit value, separated into an in phase amplitude component and a quadrature-phase amplitude component.

The horizontal axis of the graph of FIG. 3 represents the in-phase amplitude (I amplitude), and the vertical axis represents the quadrature-phase amplitude (Q amplitude). In the graph of FIG. 3, the output signal from the qubit device 110 is measured multiple times, and points are plotted on the coordinate values of the in-phase amplitude (I amplitude) and quadrature-phase amplitude (Q amplitude) for each measurement.

In the graph of FIG. 3, the reference signal is set to a phase that is orthogonal to the oscillation output of the qubit device 110. The Q amplitude is shown as a positive value in the case where the first coherent state is read, and the Q amplitude is shown as a negative value in the case where the qubit device 110 is read as the second coherent state.

Moreover, in the graph of FIG. 3, the distance from the origin (radial distance) corresponds to the oscillation amplitude, and the deflection angle corresponds to the phase of the signal.

Additionally, the graph of FIG. 3 shows the results of numerical computations, with separate plots for the case where the correct answer is the first coherent state (white dots) and the case where the correct answer is the second coherent state (black dots).

In the example of FIG. 3, compared to FIG. 2, the average photon count is larger, and the noise is smaller. As a result, the example of FIG. 3 is considered to allow for higher accuracy in reading the bit value compared to the example of FIG. 2.

Control of quantum annealing is expected to enhance the accuracy of bit value readout by utilizing the readout qubit device 112 in a case where the photon count of the output signal from the computational qubit device 111 is low or the noise level is high.

Specifically, the output signal of the computational qubit device 111 is input to the readout qubit device 112, and the interaction between these qubit devices, as well as the control of the readout qubit device 112, are configured such that the readout qubit device 112 indicates the same bit value as the computational qubit device 111.

The control of the computational qubit device 111 and the control of interactions among the computational qubit devices 111 are executed in accordance with the target problem of the quantum annealing. On the other hand, the control of the readout qubit device 112 and the interactions between the computational qubit device 111 and the readout qubit device 112 are not restricted to following by the target problem of the quantum annealing, offering increased flexibility. Thus, the control of the readout qubit device 112 and the control of the interactions therebetween can be configured to enable the output signal of the readout qubit device 112 to read bit values with greater accuracy than the output signal of the computational qubit device 111.

Therefore, it is expected that reading the bit value from the readout qubit device 112 achieves greater accuracy compared to directly reading the bit value from the output of the computational qubit device 111.

The coupler 120 allows multiple qubit devices 110 to interact with each other. The interaction of multiple qubit devices 110 is also referred to as the coupling of those qubit devices.

Among couplers, a coupler that allows two qubit devices to interact with each other is also referred to as a two-qubit coupler.

One computational qubit device 111 and one readout qubit device 112 are coupled by a two-qubit coupler 121. Then, the readout qubit device 112 and the two-qubit coupler 121 are controlled so that the readout qubit device 112 indicates the same bit value as the computational qubit device 111.

The control device 200 controls the information processing device 100 and also reads out the results of computations performed by the information processing device 100. The control device 200 may be implemented using a classical computer (of the von Neumann architecture).

The control unit 210 controls the information processing device 100. The control unit 210 serves as an example of the control means.

The observation unit 220 reads out the results of the computations performed by the information processing device 100.

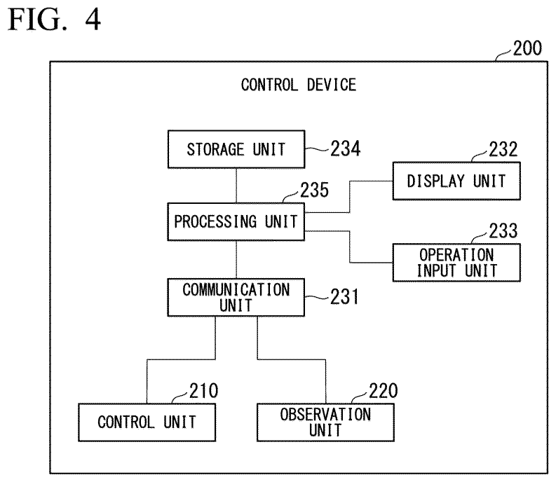

FIG. 4 is a diagram showing a configuration example of the control device 200. In the configuration shown in FIG. 4, the control device 200 includes the control unit 210, the observation unit 220, a communication unit 231, a display unit 232, an operation input unit 233, a storage unit 234, and a processing unit 235.

The communication unit 231, the display unit 232, the operation input unit 233, the storage unit 234, and the processing unit 235 may be configured using a computer (classical computer). The control device 200 may be configured as an integrated device, or may be configured as a combination of multiple devices.

The communication unit 231 communicates with the control unit 210 and the observation unit 220. For example, the control unit 210 may be connected to the communication unit 231 via a signal line such as a bus. Then, based on the control signals received from the processing unit 235 through the communication unit 231, the control unit 210 may generate control signals for each qubit device 110 and each coupler 120 using analog signals.

In addition, the control unit 210 and the observation unit 220 may be connected to each qubit device 110 and each coupler 120 via signal lines, such as coaxial cables for microwave signals. Then, the control unit 210 may transmit a control signal as an analog signal to each qubit device 110 and each coupler 120. Moreover, the observation unit 220 may receive an output signal of the qubit device 110. For example, the observation unit 220 may digitize an analog signal received from the qubit device 110. The digital signal may then be received by the processing unit 235 via the communication unit 231.

The display unit 232 includes a display screen such as a liquid crystal panel or a light emitting diode (LED) panel, and acquires various types of images. For example, the display unit 232 may display various information related to quantum annealing, such as the results of quantum annealing.

The operation input unit 233 includes input devices such as a keyboard and a mouse, and accepts user operations. For example, the operation input unit 233 may allow the user to make various quantum annealing settings, such as setting the number of execution repetitions for quantum annealing.

The storage unit 234 stores various types of data. For example, the storage unit 234 may store various quantum annealing data, such as the control schedule for the information processing device 100 and the results of individual quantum annealing executions.

The storage unit 234 is configured using a storage device included in the control device 200.

The processing unit 235 controls each unit of the control device 200 and executes various processes. Functions of the processing unit 235 are executed by a central processing unit (CPU) included in the control device 200, reading out a program from the storage unit 234 and executing the program.

The control unit 210 controls the information processing device 100 as described above.

The observation unit 220 reads out the results of the computations performed by the information processing device 100. The observation unit 220 then digitizes the acquired output signal of the readout qubit device 112. The observation unit 220 or the processing unit 235 determines the bit value indicated by the readout qubit device 112 based on the digital signal.

Bit value determination based on digital signals can be performed, for example, through a process of calculating the I amplitude and Q amplitude from a time-series numerical array represented by the digital signals, and then a process of determining the bit value based on the I amplitude and Q amplitude. The observation unit 220 may perform these processes, or the processing unit 235 may perform these processes. Alternatively, the observation unit 220 may calculate the I amplitude and the Q amplitude, and the processing unit 235 may determine the bit value based on the I amplitude and the Q amplitude.

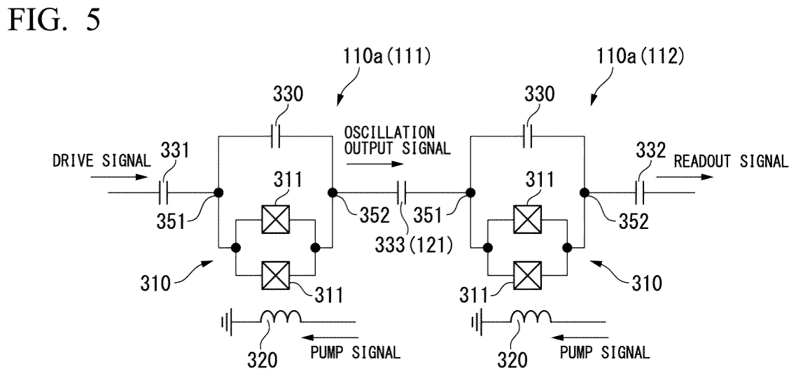

FIG. 5 is a diagram showing a first example of a combination of the computational qubit device 111 and the readout qubit device 112. FIG. 5 shows an example in which a lumped-element Josephson parametric oscillator is used as the qubit device 110. The lumped-element Josephson parametric oscillator is also referred to as a lumped-element qubit device 110a.

In the example of FIG. 5, two lumped-element qubit devices 110a are coupled by the two-qubit coupler 121 implemented using a capacitor 333.

In the lumped-element qubit device 110a, a loop is formed of a superconducting quantum interference device (SQUID) 310, which consists of two Josephson junctions 311, and a capacitor 330. Moreover, an inductor (coil) 320 is provided near the superconducting quantum interference device 310 for inputting a pump signal by applying a magnetic field into the annular structure of the superconducting quantum interference device 310.

In the loop formed of the superconducting quantum interference device 310 and the capacitor 330, two terminals are provided at positions where the superconducting quantum interference device 310 and the capacitor 330 are connected in parallel. In the configuration of FIG. 5, the two terminals of both the computational qubit device 111 and the readout qubit device 112 are used as a terminal for signal input and a terminal for signal output. The signal input end is also referred to as input terminal 351, and the signal output end is also referred to as output terminal 352.

In the lumped-element qubit device 110a serving as the computational qubit device 111, the input terminal 351 is connected to the capacitor 331, and a drive signal is input to the input terminal 351 via the capacitor 331. The oscillation output is output externally via the capacitors 331, 333, which are connected to the input terminal 351 and the output terminal 352, respectively.

Here, the signal output externally via the capacitor 331 connected to the input terminal 351 may be observed by the observation unit 220. However, in such a case, it is possible that control for quantum annealing may result in the computational qubit device 111 not being in the state appropriate for reading out the bit value, which could lead to readout results that fail to distinguish the bit states, as shown in FIG. 2.

The oscillation signal output by the lumped-element qubit device 110a serving as the computational qubit device 111 is also referred to as an oscillation output signal. The oscillation output signal is input to the lumped-element qubit device 110a serving as the readout qubit device 112 via capacitor 333 serving as the two-qubit coupler 121.

In the lumped-element qubit device 110a serving as the readout qubit device 112, the oscillation output signal from the computational qubit device 111 is input to the input terminal 351 of the readout qubit device 112 via the capacitor 333 serving as the two-qubit coupler 121. The oscillation signal from the lumped-element qubit device 110a serving as the readout qubit device 112 is output externally via the capacitors 333, 332 connected to the input terminal 351 and the output terminal 352 of the readout qubit device 112, respectively. Of these, the oscillation signal that is output from the output terminal 352 of the readout qubit device 112 via the capacitor 332 to the control device 200 is also referred to as readout signal. Since the control of the lumped-element qubit device 110a serving as the readout qubit device 112 is not constrained by quantum annealing, it can be brought into a state suitable for reading, potentially resulting in a readout result that distinguishes the bit states, as shown in FIG. 3.

A Josephson parametric oscillator is a superconducting nonlinear resonator that includes a superconducting quantum interference device. In the present example embodiment, the superconducting quantum interference device is an annular-shaped structure including two Josephson junctions. In a Josephson parametric oscillator, in a case where microwaves having a frequency approximately twice the resonance frequency are applied to a superconducting quantum interference device, the magnetic flux passing through the annular structure is modulated at a frequency approximately twice the resonance frequency. As a result, the resonance frequency itself is subjected to parameter modulation at a frequency approximately twice the original resonance frequency, and the Josephson parametric oscillator oscillates parametrically at half the frequency of the applied microwave. The microwave applied at this time is referred to as a pump signal. The frequency of a pump signal is referred to as pump frequency.

The parametric oscillation performed by the Josephson parametric oscillator can take one of two oscillation states, either in phase or II out of phase, relative to the pump signal. By treating these two oscillation states as two levels representing bit values, the bit value can be represented by the oscillation state. These two oscillation states correspond to the two coherent states mentioned above.

In quantum computing using the Josephson parametric oscillator, the technique of adiabatic quantum computation is used. To adiabatically change the state of a qubit device, control parameter values must be set such that an adiabatic transition occurs from the initial state to the final state. To achieve this, the ground state before excitation must align with the ground state in the coordinate system after excitation.

Here, in the ground state before excitation, no pump signal is input, and the photon count in the Josephson parametric oscillator is zero.

Moreover, a rotating coordinate system is used as the coordinate system after excitation. The Hamiltonian H/h in the rotating coordinate system is expressed, for example, as Expression (1).

$$H / h = {Δ a}^{†} a - \frac{𝒳}{2} {a}^{†} {a}^{†} aa + β ( aa + {a}^{†} {a}^{†} ) \qquad ( 1 )$$

Δ is a value determined according to the frequency difference between the resonance frequency ωᵣ of the Josephson parametric oscillator and half the pump frequency ωₚ, and is expressed as Expression (2).

$$Δ = {ω}_{r} - \frac{{ω}_{p}}{2} \qquad ( 2 )$$

The symbol “a” with a dagger (†) superscript denotes a creation operator.

The symbol “a” denotes an annihilation operator.

The symbol χ denotes a nonlinearity.

The symbol β denotes a pump signal intensity. The pump signal intensity is also referred to as pump intensity.

If the photon count in the Josephson parametric oscillator is n, then in a case where β=0, the energy is given by nΔ−n(n−1)χ/2. Here, n is an integer where n≥0. In general, in a case where χ>0 and Δ<0, the state with zero photons, which corresponds to the ground state for β=0, becomes the maximum energy state. In other words, if Δ<0, the energy is maximized in a case where n=0 among n=0, 1, 2, . . .

In a case where Δ<0 in Expression (2), ωₚ>2ωᵣ.

The energy ground state after parametric oscillation is a coherent state, and in the rotating coordinate system, this coherent state represents the state with the maximum energy. Therefore, to adiabatically change the state of the Josephson parametric oscillator, it is necessary to ensure that the state with zero photons is the energy maximum state in a case where β=0. In other words, the pump frequency ωₚ should be set to a value greater than twice the resonant frequency ωᵣ of the Josephson parametric oscillator. In this case, by gradually changing the pump signal intensity β from 0 to a finite value, the state of the Josephson parametric oscillator can be adiabatically evolved, and it is expected that the state corresponding to the optimal solution will be obtained.

On the other hand, considering the case where the initial state is not the ground state, a relaxation process involving interactions with photon exchanges must occur before reaching the state corresponding to the optimal solution. Therefore, if the initial state is not the ground state, it is expected that time will be required before reaching the state corresponding to the optimal solution. Additionally, if the initial state is not the ground state, transitions to non-optimal states may also occur simultaneously.

In this way, it is preferable to set the pump frequency ωₚ to a value greater than twice the resonant frequency ωᵣ of the Josephson parametric oscillator, in order to adiabatically change the state of the Josephson parametric oscillator.

In contrast, in a case where the pump frequency ωₚ is set to a value greater than twice the resonant frequency ωᵣ of the Josephson parametric oscillator, the intensity of the output oscillation signal output by the Josephson parametric oscillator becomes relatively weaker. Here, the Josephson parametric oscillator, after excitation, enters the coherent state, and the average photon count N in the coherent state is approximately given by Expression (3).

$$N = ( 2 β + Δ ) / 𝒳 \qquad ( 3 )$$

In Expression (3), the larger the value of Δ, the greater the average photon count N, and the stronger the intensity of the oscillation signal becomes. In a case where Δ<0, that is, in a case where the pump frequency ωₚ is greater than twice the resonance frequency ωᵣ of the Josephson parametric oscillator, the intensity of the oscillation signal is weaker than in a case where Δ≥0. It is considered that the accuracy of reading out the bit value decreases if the intensity of the oscillation signal of the Josephson parametric oscillator cannot be made sufficiently strong.

In addition to increasing the value of Δ in Expression (3) to increase the average photon count N, it is also possible to increase the pump signal intensity β and reduce the nonlinearity χ. However, both β and χ have upper and lower limit values that are determined by the experimental conditions. Therefore, increasing the value of the pump signal intensity β and decreasing the value of the nonlinearity χ imposes limitations on increasing the average photon count.

Additionally, in a case where reading the bit value from the oscillation signal of the Josephson parametric oscillator, amplifying the oscillation signal with an amplifier before reading the bit value may be considered. However, amplifying the oscillation signal results in the amplification of the noise contained within the signal as well. As shown in the example of FIG. 2, in a case where the average photon count is relatively small, it may be difficult to distinguish between the two coherent states, even with use of the amplified oscillation signal.

In order to accurately read the bit value from the oscillation signal of the Josephson parametric oscillator, it is necessary for the average photon count in the oscillation signal before amplification to be sufficiently large, as shown in the example of FIG. 3, and for the intensity of the oscillation signal to be sufficiently high relative to the noise level.

Therefore, the information processing device 100 is provided with the readout qubit device 112. The observation unit 220 reads the bit value from the readout qubit device 112 rather than directly from the computational qubit device 111.

As mentioned above, the readout qubit device 112 is a qubit device 110 that is not directly used in bit value computation through quantum computing, and provides greater flexibility in control compared to the computational qubit device 111. As a result, the control unit 210 can perform control better suited for bit value readout on the readout qubit device 112, which is expected to enable bit value reading with relatively high accuracy.

For example, in a case where the qubit device 110 is configured using a Josephson parametric oscillator as in the example of FIG. 5, the pump frequency ωₚ for the computational qubit device 111 may be set to a value greater than twice the resonance frequency ωᵣ of the Josephson parametric oscillator. As a result, the control unit 210 can adiabatically change the state of the computational qubit device 111.

On the other hand, for the readout qubit device 112, the pump frequency ωₚ may be set to a value less than or equal to twice the resonance frequency ωᵣ of the Josephson parametric oscillator. As a result, the intensity of the readout signal (the oscillation signal output by the readout qubit device 112) can be increased, enabling the observation unit 220 to read out the bit value with relatively high accuracy.

Additionally, since there is no need to change the state of the readout qubit device 112 adiabatically, the value of the nonlinearity parameter χ can be reduced compared to that of the computational qubit device 111. In this respect also, the intensity of the readout signal can be increased, allowing the observation unit 220 to read out the bit value with relatively high accuracy.

For the two-qubit-coupler, two Josephson parametric oscillators are connected by a capacitor. By inputting pump signals of the same frequency to these two Josephson parametric oscillators, they can be two-qubit-coupled. In the example of FIG. 5, pump signals of the same frequency are input to the computational qubit device 111 and the readout qubit device 112. It should be noted that the term “same frequency” here does not strictly mean exactly the same frequency. It is sufficient if the frequencies are close enough to ensure that the phase difference does not exceed π/2 during the readout time.

As for the resonance frequency, as mentioned above, for the computational qubit device 111, it is possible to set the pump frequency ωₚ to a value greater than twice the resonance frequency ωᵣ of the Josephson parametric oscillator. For the readout qubit device 112, the pump frequency ωₚ can be set to a value equal to or less than twice the resonance frequency ωᵣ of the Josephson parametric oscillator.

Thus, the following relationship may be satisfied: the resonance frequency of the computational qubit device 111 is less than half the common pump frequency for the computational qubit device 111 and the readout qubit device 112, which is, in turn, less than the resonance frequency of the readout qubit device 112.

The strength of the two-qubit-coupling between the two Josephson parametric oscillators can be varied by the phase difference of the pump signals of these two Josephson parametric oscillators. Accordingly, the control unit 210 may adjust the relative phase of the pump signal for the readout qubit device 112 with respect to the pump signal for the computational qubit device 111, so that the strength of the two-qubit-coupling between the computational qubit device 111 and the readout qubit device 112 becomes as strong as possible.

By two-qubit-coupling the computational qubit device 111 and the readout qubit device 112, a correlation occurs between the oscillation phases of these two qubit devices 110. As a result, the readout qubit device 112 is expected to indicate the same bit value as that indicated by the computational qubit device 111.

In particular, since the readout qubit device 112 is two-qubit-coupled to the computational qubit device 111, unlike the case of four-qubit coupling, the readout qubit device 112 interacts only with this computational qubit device 111. In this respect, the oscillation phase of the readout qubit device 112 can be directly reflected by the oscillation phase of the computational qubit device 111.

Here, if the oscillation phase of the computational qubit device 111 is influenced by the oscillation phase of the readout qubit device 112 due to the two-qubit-coupling, the computation accuracy of the bit value by quantum computing may be reduced. In particular, it is considered that the oscillation phase of the computational qubit device 111 is more likely to be influenced by the oscillation phase of the readout qubit device 112 in a case where the oscillation signal intensity of the readout qubit device 112 is higher than that of the computational qubit device 111.

To avoid or mitigate such influence, the control unit 210 may be configured to initiate the excitation of the readout qubit device 112 after the state transition of the computational qubit device 111 has been completed and the computational qubit device 111 has reached the coherent state. That is to say, the control unit 210 may be configured to initiate inputting the pump signal to the readout qubit device 112 and transition the state of the readout qubit device 112 after the state transition of the computational qubit device 111 has been completed.

In the example shown in FIG. 5, the input of the drive signal and the output of the oscillation output signal are performed at different terminals of the computational qubit device 111. This eliminates the need for a mechanism, such as a circulator, to separate the output signal and the input signal, compared to the case where the drive signal is input and the oscillation output signal is output at the same terminal of the Josephson parametric oscillator.

Furthermore, the computational qubit device 111 can, in a state receiving the drive signal input, output the oscillation output signal, which can be input to the readout qubit device 112 via the two-qubit coupler 121. This enables the stabilization of the oscillation output signal from the computational qubit device 111, which is expected to improve the accuracy of bit value reading performed by the observation unit 220.

Moreover, in the example shown in FIG. 5, the input of the oscillation output signal from the computational qubit device 111 and the output of the readout signal are performed at different terminals of the readout qubit device 112. This eliminates the need for a mechanism, such as a circulator, to separate the output signal and the input signal, compared to the case where the drive signal is input and the oscillation output signal is output at the same terminal of the Josephson parametric oscillator.

Also, the readout qubit device 112 can output the readout signal while receiving an input of the oscillation output signal. This enables the stabilization of the readout signal output from the readout qubit device 112, which is expected to improve the accuracy of bit value reading performed by the observation unit 220.

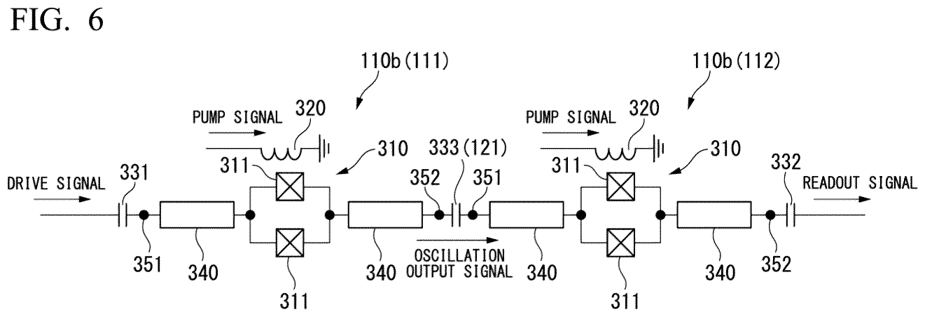

FIG. 6 is a diagram showing a second example of a combination of the computational qubit device 111 and the readout qubit device 112. FIG. 6 shows an example in which a distributed-element Josephson parametric oscillator is used as the qubit device 110. The distributed-element Josephson parametric oscillator is also referred to as distributed-element qubit device 110b.

In the example of FIG. 6, two distributed-element qubit devices 110b are coupled by the two-qubit coupler 121 implemented using a capacitor 333.

In the distributed-element qubit device 110b, a superconducting quantum interference device 310, which has an annular structure with two Josephson junctions 311, is positioned between two quarter-wavelength (λ/4) resonators 340. The quarter-wavelength resonator 340, the superconducting quantum interference device 310, and the quarter-wavelength resonator 340 are connected in series in this order. Also, an inductor 320 for inputting a pump signal is provided near one of the two Josephson junctions.

Of the two terminals of the quarter-wavelength resonators 340, the terminal that is not connected to the superconducting quantum interference device 310 corresponds to the terminal of the distributed-element qubit device 110b.

In the distributed-element qubit device 110b serving as the computational qubit device 111, the input terminal 351 is connected to the capacitor 331, and a drive signal is input to the input terminal 351 via the capacitor 331. Moreover, an oscillation signal is output from the output terminal 352.

The oscillation signal output by the distributed element qubit device 110b serving as the computational qubit device 111 is also referred to as oscillation output signal. The oscillation output signal is input to the distributed-element qubit device 110b serving as the readout qubit device 112 via capacitor 333 serving as the two-qubit coupler 121.

In the distributed element qubit device 110b serving as the readout qubit device 112, the oscillation output signal is input to the input terminal 351 via the capacitor 333 serving as the two-qubit coupler 121. Moreover, the output terminal 352 is connected to the capacitor 332, and the oscillation signal is output from the output terminal 352 to the control device 200 via the capacitor 332. The oscillation signal output by the distributed-element qubit device 110b serving as the readout qubit device 112 is also referred to as readout signal.

Also in the case where the distributed-element qubit device 110b is used as a qubit device 110, the pump frequency ωₚ for the computational qubit device 111 may be set to a value greater than twice the resonance frequency ωᵣ of the Josephson parametric oscillator. As a result, the control unit 210 can adiabatically change the state of the computational qubit device 111.

Moreover, for the readout qubit device 112, the pump frequency ωₚ may be set to a value less than or equal to twice the resonance frequency ωᵣ of the Josephson parametric oscillator. As a result, the intensity of the readout signal (the oscillation signal output by the readout qubit device 112) can be increased, enabling the observation unit 220 to read out the bit value with relatively high accuracy.

Also in the example of FIG. 6, since there is no need to change the state of the readout qubit device 112 adiabatically, the value of the nonlinearity parameter χ can be reduced compared to that of the computational qubit device 111. In this respect also, the intensity of the readout signal can be increased, allowing the observation unit 220 to read out the bit value with relatively high accuracy.

Also in the example of FIG. 6, by inputting a pump signal of the same frequency to both the computational qubit device 111 and the readout qubit device 112, it is possible to two-qubit-couple the computational qubit device 111 and the readout qubit device 112. It should be noted that the term “same frequency” here does not strictly mean exactly the same frequency. It is sufficient if the frequencies are close enough to ensure that the phase difference does not exceed π/2 during the readout time.

Also in the example of FIG. 6, the control unit 210 may adjust the relative phase of the pump signal for the readout qubit device 112 with respect to the pump signal for the computational qubit device 111, so that the strength of the two-qubit-coupling between the computational qubit device 111 and the readout qubit device 112 becomes as strong as possible.

Also in the example of FIG. 6, by two-qubit-coupling the computational qubit device 111 and the readout qubit device 112, a correlation occurs between the oscillation phases of these two qubit devices 110. As a result, the readout qubit device 112 is expected to indicate the same bit value as that indicated by the computational qubit device 111.

In particular, since the readout qubit device 112 is two-qubit-coupled to the computational qubit device 111, unlike the case of four-qubit coupling, the readout qubit device 112 interacts only with this computational qubit device 111. In this respect, the oscillation phase of the readout qubit device 112 can be directly reflected by the oscillation phase of the computational qubit device 111.

Also in the example of FIG. 6, the control unit 210 may be configured to initiate the excitation of the readout qubit device 112 after the state transition of the computational qubit device 111 has been completed and the computational qubit device 111 has reached the coherent state. That is to say, the control unit 210 may be configured to initiate inputting the pump signal to the readout qubit device 112 and transition the state of the readout qubit device 112 after the state transition of the computational qubit device 111 has been completed.

Also in the example shown in FIG. 6, the input of the drive signal and the output of the oscillation output signal are performed at different terminals of the computational qubit device 111. This eliminates the need for a mechanism, such as a circulator, to separate the output signal and the input signal, compared to the case where the drive signal is input and the oscillation output signal is output at the same terminal of the Josephson parametric oscillator.

Also in the example of FIG. 6, the computational qubit device 111 can, in a state receiving the drive signal input, output the oscillation output signal, which can be input to the readout qubit device 112 via the two-qubit coupler 121. This enables the stabilization of the oscillation output signal from the computational qubit device 111, which is expected to improve the accuracy of bit value reading performed by the observation unit 220.

Also in the example of FIG. 6, the input of the oscillation output signal from the computational qubit device 111 and the output of the readout signal are performed at different terminals of the readout qubit device 112. This eliminates the need for a mechanism, such as a circulator, to separate the output signal and the input signal, compared to the case where the drive signal is input and the oscillation output signal is output at the same terminal of the Josephson parametric oscillator.

Also in the example of FIG. 6, the readout qubit device 112 can output the readout signal while receiving an input of the oscillation output signal. This enables the stabilization of the readout signal output from the readout qubit device 112, which is expected to improve the accuracy of bit value reading performed by the observation unit 220.

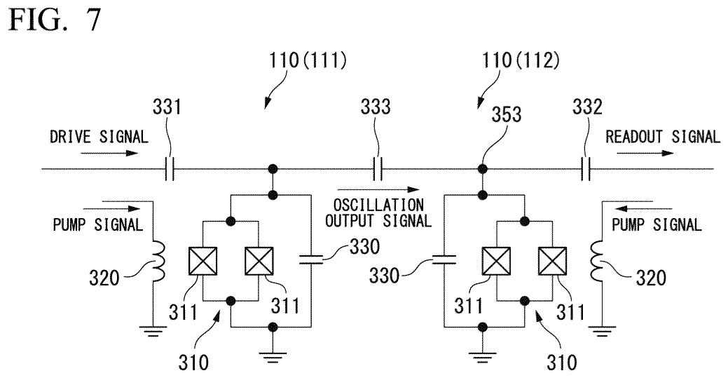

FIG. 7 is a diagram showing a third example of a combination of the computational qubit device 111 and the readout qubit device 112. FIG. 7 shows another example in which a lumped-element Josephson parametric oscillator is used as the qubit device 110.

In the example of FIG. 7, the manner in which the loop formed of the superconducting quantum interference device 310 and the capacitor 330 is set up differs from that in FIG. 5.

In FIG. 7, for both the computational qubit device 111 and the readout qubit device 112, one of the two terminals, where the superconducting quantum interference device 310 and the capacitor 330 are arranged in a parallel connection, is connected to the signal path. The other of the two terminals is grounded (GND).

In other respects, the example of FIG. 7 is similar to that in the case of FIG. 5.

Thus, it is possible for only one of the two terminals of the loop between the superconducting quantum interference device 310 and the capacitor 330 to be connected to the signal path. This terminal is also referred to as input/output terminal 353.

It is also possible for a lumped-element Josephson parametric oscillator and a distributed-element Josephson parametric oscillator to be used together. For example, a lumped-element qubit device 110a may be used as the computational qubit device 111, and a distributed-element qubit device 110b may be used as the readout qubit device 112. Alternatively, the distributed-element qubit device 110b may be used as the computational qubit device 111, while the lumped-element qubit device 110a may be used as the readout qubit device 112.

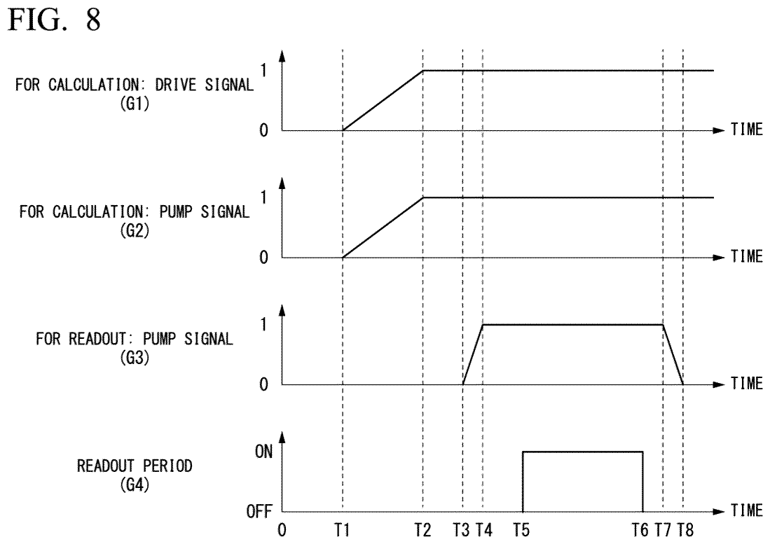

FIG. 8 is a diagram showing an example of control timing for the computational qubit device 111 and the readout qubit device 112.

In FIG. 8, graphs G1 to G4 are shown aligned in time. The graph G1 is a graph showing the input timing of a drive signal to the computational qubit device 111. The graph G2 is a graph showing the input timing of a pump signal to the computational qubit device 111. The graph G3 is a graph showing the input timing of a pump signal to the readout qubit device 112. The graph G4 is a graph showing the read timing of a readout signal from the readout qubit device 112.

The horizontal axis of each graph represents the time elapsed from a predetermined reference time.

The vertical axis of graphs G1 to G3 represents the intensity of the input signal to the qubit device 110, normalized to a value within the range of 0 to 1. The value 0 on the vertical axis indicates the signal intensity in a case where no signal is input to the qubit device 110. The value 1 on the vertical axis indicates the signal intensity that is set as a steady-state value.

The vertical axis of the graph G4 represents the distinction between “ON” and “OFF” of the readout period. The readout period here refers to a temporal period during which an oscillation signal from the qubit device 110 is read out. The readout period being “ON” indicates a timing in a case where the observation unit 220 is reading out the oscillation signal. The readout period being “OFF” indicates a timing in a case where the observation unit 220 is not reading out the oscillation signal.

In the example of FIG. 8, the control unit 210 starts inputting the drive signal and pump signal to the computational qubit device 111 at time T1, and at time T2, the intensity of these signals is set to the steady-state value. Before time T1, in a case where the pump signal is not being input, the state of the computational qubit device 111 is in its initial state. After time T2, in a case where the intensity of the pump signal has reached the steady-state value, the state of the computational qubit device 111 becomes the coherent state (that is, a state in which the qubit value is determined as being one of two binary values).

Moreover, the control unit 210 starts the input of the pump signal to the readout qubit device 112 at time T3, after time T2, and at time T4, the intensity of the pump signal is set to the steady-state value. Before time T3, in a case where the pump signal is not being input, the state of the readout qubit device 112 is in its initial state. After time T4, in a case where the intensity of the pump signal has reached the steady-state value, the state of the readout qubit device 112 becomes the coherent state.

The observation unit 220 reads the readout signal (the oscillation signal from the readout qubit device 112) during the readout period, which spans from time T5 to T6, after the pump signal intensity of the readout qubit device 112 has reached the steady-state value at time T4.

After time T6, from time T7 to time T8, the control unit 210 reduces the intensity of the pump signal to the readout qubit device 112, and at time T8, the input of the pump signal to the readout qubit device 112 is terminated.

Thus, in the example of FIG. 8, the control unit 210 can input the pump signal to the readout qubit device 112 and initiate excitation after the time in a case where the computational qubit device 111 has reached the coherent state. This makes it possible to prevent or mitigate the influence of the oscillation phase of the computational qubit device 111 on the oscillation phase of the readout qubit device 112, as described above.

Moreover, by inputting a pump signal such that Δ>0 to the Josephson parametric oscillator and inputting a drive signal, the Josephson parametric oscillator can be excited in synchronization with the drive signal.

Therefore, after the computational qubit device 111 reaches the coherent state, the control unit 210 may input a pump signal to the readout qubit device 112 such that Δ>0. As a result, the readout qubit device 112 is expected to oscillate in the same phase as the oscillation phase of the computational qubit device 111, allowing the observation unit 220 to read out the bit value represented by the computational qubit device 111 from the readout qubit device 112.

Additionally, the condition Δ>0 corresponds to the pump frequency ωₚ being less than twice the resonance frequency ωᵣ of the Josephson parametric oscillator. Therefore, as described above, the intensity of the oscillation signal from the readout qubit device 112 becomes relatively high, which is expected to enable the observation unit 220 to read out the bit value indicated by the readout qubit with relatively high accuracy.

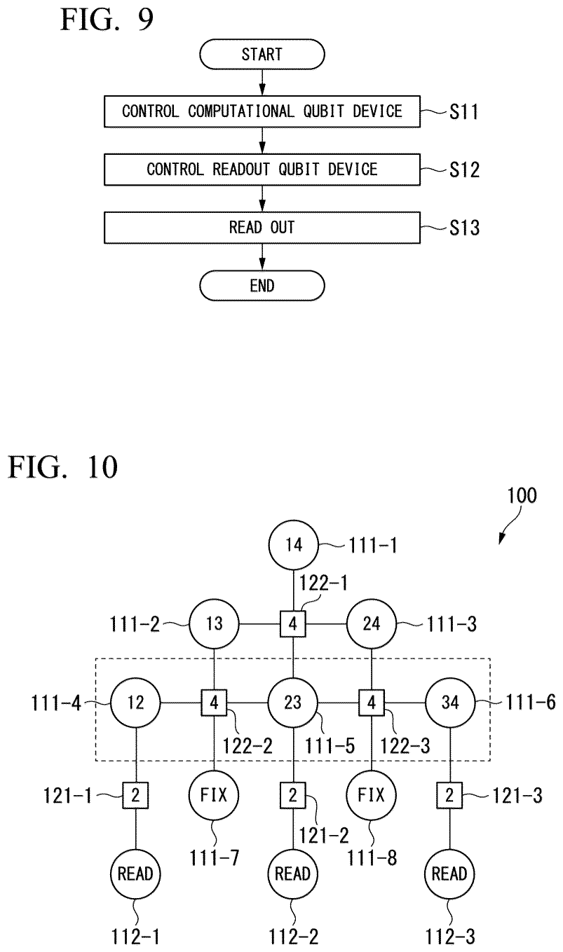

FIG. 9 is a diagram showing an example of a procedure of processing performed by the control device 200. FIG. 9 shows an example of the procedure of processing performed by the control device 200 during a single solution search in quantum annealing. The control device 200 repeats the process shown in FIG. 9 for each iteration of the solution search in quantum annealing.

In the process shown in FIG. 9, the control unit 210 controls the computational qubit device 111 (Step S11). Specifically, the control unit 210 inputs control signals, such as a pump signal, to the computational qubit device 111 through the communication unit 231.

After the state of the computational qubit device 111 reaches the coherent state, the control unit 210 performs control over the readout qubit device 112 (Step S12). Specifically, the control signals, such as a pump signal, are input from the control unit 210 to the readout qubit device 112.

After the state of the readout qubit device 112 reaches the coherent state, the observation unit 220 reads out the bit value from the readout qubit device 112 (Step S13). Specifically, the observation unit 220 estimates the bit value by measuring the phase of the readout signal, which is the oscillation signal output by the readout qubit device 112.

After Step S13, the control device 200 ends the process of FIG. 9. The term “end” here refers to the termination of the output from the control unit 210 and the measurement of the readout signal performed by the observation unit 220.

In the example provided here, the information processing qubit is described as a computational qubit. However, the information processing qubit may also be used for purposes other than computation. As described above for computational qubit devices, a computational qubit is a qubit that is used to perform a computation. An information processing qubit is a quantum bit that is used widely for information processing, not limited to computations. For example, information processing qubits may be used as storage qubits.

As described above, the readout qubit device 112 is coupled by the coupler 120 to the information processing qubit device so as to assume the same bit value as the information processing qubit device.

In the information processing device 100, the control of the readout qubit device 112 does not need to be the same as that for an information processing qubit device, and the degree of freedom for controlling the readout qubit device 112 is relatively high. As a result, it is expected that the information processing device 100 will be able to control the readout qubit device 112 in a manner more suitable for reading out bit values, thereby making it possible to read out bit values with higher accuracy.

Moreover, the information processing qubit device is a computational qubit device 111.

In the information processing device 100, under the control of the control device 200, computations such as quantum annealing can be performed.

Also, the readout qubit device 112 and the computational qubit device 111 coupled to each other are excited at the same frequency. It should be noted that the term “same frequency” here does not strictly mean exactly the same frequency. It is sufficient if the frequencies are close enough to ensure that the phase difference does not exceed II/2 during the readout time.

As a result, in the information processing device 100, these two qubit devices 110 can be coupled such that the readout qubit device 112 has the same bit value as the computational qubit device 111. As a result, it is expected that in the information processing device 100, the same bit value as the bit value of the computational qubit device 111 can be read out from the readout qubit device 112.

Furthermore, the pump frequency of the computational qubit device 111 is higher than twice the resonance frequency. The pump frequency of the readout qubit device 112 is lower than twice the resonance frequency.

In the information processing device 100, the pump frequency of the computational qubit device 111 is higher than twice the resonance frequency, so that the state of the computational qubit device 111 can be changed adiabatically. Moreover, by making the pump frequency of the readout qubit device 112 lower than twice the resonance frequency, the intensity of the oscillation signal of the readout qubit device 112 can be made relatively high. In this respect, according to the information processing device 100, it is expected that the bit value can be read out with relatively high accuracy.

Also, the readout qubit device 112 and the computational qubit device 111 coupled to each other are excited at the same pump frequency. The resonance frequency of the computational qubit device 111 is lower than one-half the pump frequency, and the resonance frequency of the readout qubit device 112 is higher than one-half the pump frequency.

In the information processing device 100, the readout qubit device 112 and the computational qubit device 111 are excited at the same pump frequency, so that these two qubit devices 110 can be two-qubit coupled so as to take the same value. As a result, it is expected that in the information processing device 100, the same bit value as the bit value of the computational qubit device 111 can be read out from the readout qubit device 112.

In the information processing device 100, the resonance frequency of the computational qubit device 111 is lower than one-half the pump frequency, so that the state of the computational qubit device 111 can be changed adiabatically. Moreover, since the resonance frequency of the readout qubit device 112 is higher than one-half the pump frequency, the oscillation signal phase of the readout qubit device 112 can be synchronized with that of the computational qubit device 111, and the intensity of the oscillation signal from the readout qubit device 112 can be made relatively high. In this respect, according to the information processing device 100, it is expected that the bit value can be read out with relatively high accuracy.

Furthermore, the control unit 210 can excite the readout qubit device 112 after the computational qubit device 111 reaches the coherent state.

In this regard, it is expected that the information processing device 100 will make it easier to control the readout qubit device 112 so that the bit value of the readout qubit device 112 becomes the same value as the bit value of the computational qubit device 111. According to the information processing device 100, in this respect, it is expected that the same bit value as the bit value of the computational qubit device 111 can be read out from the readout qubit device 112.

### Second Example Embodiment

In a second example embodiment, a first example of applying the information processing system 1 to a model based on the Lechner-Hauke-Zoller (LHZ) scheme is described. A model based on the LHZ scheme is also referred to as an LHZ model.

In the second example embodiment, the configuration of the information processing device 100 is concretized from the configuration of the first example embodiment. In other respects, the information processing system 1 of the second example embodiment is similar to that of the first example embodiment.

FIG. 10 is a diagram showing the first example of the configuration of the information processing device 100 where an LHZ model is used. In the example of FIG. 10, the information processing device 100 includes eight computational qubit devices 111, three readout qubit devices 112, three two-qubit couplers 121, and three four-qubit couplers 122. Just as the two-qubit coupler 121 corresponds to an example of the coupler 120, the four-qubit coupler 122 also corresponds to an example of the coupler 120.

The configuration of the information processing device 100 shown in FIG. 10 corresponds to a specific example of the configuration of the information processing device 100 shown in FIG. 1.

In a case where distinguishing the eight computational qubit devices 111 from one another, they may be referred to as computational qubit devices 111-1, 111-2, . . . , 111-8. In a case where distinguishing the three readout qubit devices 112 from one another, they may be referred to as readout qubit devices 112-1, 112-2, and 112-3. In a case where distinguishing the three two-qubit couplers 121 from one another, they may be referred to as two-qubit couplers 121-1, 121-2, and 121-3. In a case where distinguishing the three four-qubit couplers 122 from one another, they may be referred to as four-qubit couplers 122-1, 122-2, and 122-3.

FIG. 10 shows an example in which the readout qubit devices 112 are provided in a physical model obtained by converting a fully connected 4-bit logical model using the LHZ scheme. However, the information processing device 100 is applicable to problems represented by logical models of various bit sizes, not just limited to 4 bits.

The bit value of each of the computational qubit devices 111-1 through 111-6 represents the product of two logical bits. In the representation of these computational qubit devices 111, the two digits shown in a circle indicate the identification numbers of the logical bits that are being multiplied. For example, the bit value of the computational qubit device 111-1 indicates the product of the first logical bit and the fourth logical bit.

The computational qubit devices 111-7 and 111-8 are controlled such that their bit values are fixed at +1.

Each of the four-qubit couplers 122 couples four computational qubit devices 111. In the representation of the four-qubit coupler 122, the digit “4” shown in a square indicates that the coupling count (the number of qubit devices to which the coupler couples) is four.

Among the computational qubit devices 111-1 to 111-6, the computational qubit devices 111-4 to 111-6 are targets for bit value reading. However, the observation unit 220 reads the bit value from the readout qubit device 112 rather than directly from the computational qubit device 111.

The configuration in FIG. 10 can be interpreted as a configuration in which the computational qubit devices 111 and the four-qubit couplers 122 form a model based on the LHZ scheme, with the readout qubit devices 112 being incorporated via the two-qubit couplers 121.

Furthermore, each of the multiple qubit devices 110 is configured using a nonlinear oscillator. Of the readout qubit device 112 and the computational qubit device 111 coupled to each other, it is considered that the nonlinearity of the readout qubit device 112 is made lower than that of the computational qubit device 111.

According to the information processing device 100, since the nonlinearity of the readout qubit device 112 is lower than the nonlinearity of the computational qubit device 111, it is expected that the intensity of the output signal of the readout qubit device 112 can be made higher than the intensity of the output signal of the computational qubit device 111. According to the information processing device 100, in this respect, it is expected that the bit value can be read out with higher accuracy compared to directly reading out the bit value from the computational qubit device 111.

Each of the readout qubit devices 112 is coupled to a corresponding computational qubit device 111 by the two-qubit coupler 121. The readout qubit device 112 is controlled so as to display the same bit value as the computational qubit device 111 to which it is coupled. Specifically, the readout qubit device 112-1 is coupled to the computational qubit device 111-4 via the two-qubit coupler 121-1 and is controlled so as to display the same bit value as the computational qubit device 111-4. The readout qubit device 112-2 is coupled to the computational qubit device 111-5 via the two-qubit coupler 121-2 and is controlled so as to display the same bit value as the computational qubit device 111-5. The readout qubit device 112-3 is coupled to the computational qubit device 111-6 via the two-qubit coupler 121-3 and is controlled so as to display the same bit value as the computational qubit device 111-6.

In the representation of the two-qubit coupler 121, the digit “2” shown in a square indicates that the coupling count is two.

The observation unit 220 reads out the bit values from the readout qubit devices 112-1 to 112-3, thereby reading out the bit values from the computational qubit devices 111-4 to 111-6.

In a case where performing quantum annealing using the LHZ scheme with a Josephson parametric oscillator, the state is adiabatically changed until reaching the coherent state, while simultaneously inputting a pump signal to the Josephson parametric oscillator to induce interactions.

In the example shown in FIG. 10, the control unit 210 adiabatically changes the state until it reaches the coherent state, while simultaneously inputting a pump signal to the computational qubit device 111 to induce interactions. After the computational qubit device 111 reaches the coherent state, the control unit 210 inputs a pump signal to the readout qubit device 112, inducing two-qubit interactions with the computational qubit device 111. Then, the observation unit 220 reads out the bit value from the readout qubit device 112.

In the second example embodiment also, the information processing qubit is described as a computational qubit. However, the information processing qubit may also be used for purposes other than computation.

As described above, the computational qubit device 111 and one or more four-qubit couplers 122 among the couplers 120 form an LHZ scheme model.

In this respect, according to the information processing device 100, it is expected that the bit value can be read out with relatively high accuracy from the LHZ scheme model. In this respect, it is expected that the information processing device 100 will be able to calculate with higher accuracy a solution to a problem represented by a fully connected logical model.

In particular, in the information processing device 100, the control of the readout qubit device 112 does not need to be the same as that for the computational qubit device 111, and the degree of freedom for controlling the readout qubit device 112 is relatively high. As a result, it is expected that the information processing device 100 will be able to control the readout qubit device 112 in a manner more suitable for reading out bit values, thereby making it possible to read out bit values with higher accuracy.

### Third Example Embodiment

In a third example embodiment, a second example in which the information processing system 1 is applied to an LHZ model will be described.

In the third example embodiment, the configuration of the information processing device 100 is concretized from the configuration of the first example embodiment. In other respects, the information processing system 1 of the third example embodiment is similar to that of the first example embodiment.

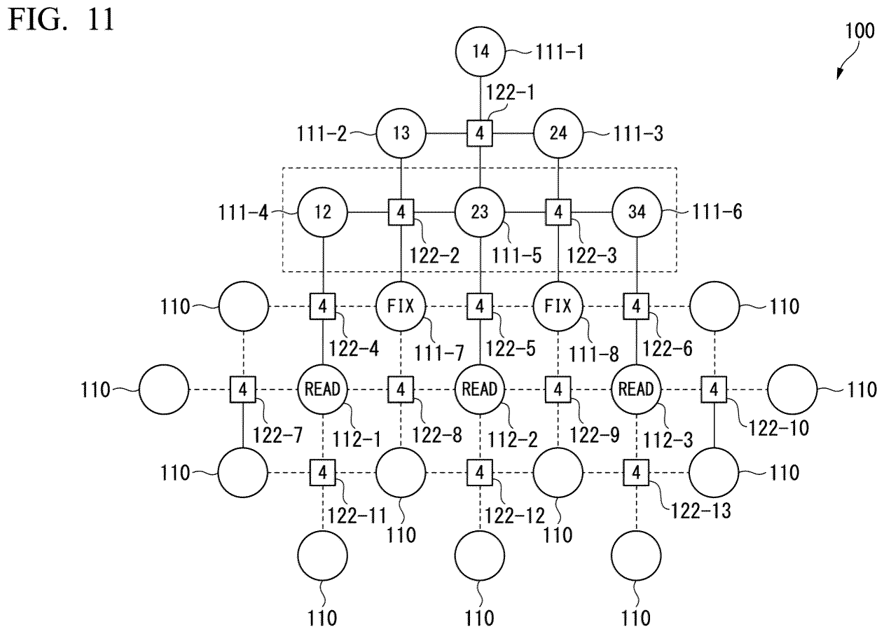

FIG. 11 is a diagram showing the second example of the configuration of the information processing device 100 where an LHZ model is used. In the example of FIG.

11, the information processing device 100 includes twenty-two qubit devices 110 and thirteen four-qubit couplers 122. Eight of the twenty two qubit devices 110 are used as computational qubit devices 111. The arrangement and application of the qubit devices 110 used as the computational qubit devices 111 are the same as those in FIG. 10. Similarly to FIG. 10, the computational qubit devices are denoted as 111-1, 111-2, . . . , 111-8.

Of the remaining fourteen qubit devices 110, three are used as readout qubit devices 112. The arrangement and application of the qubit devices 110 used as the readout qubit devices 112 are the same as those in FIG. 10. Similarly to FIG. 10, the readout qubit devices are denoted as 112-1, 112-2, . . . , 112-3.

The remaining eleven qubit devices 110 are unused.

In a case where distinguishing the four-qubit couplers 122 in the example of

FIG. 11 from one another, they may be referred to as four-qubit couplers 122-1, 122-2, . . . , 122-13.

The four-qubit couplers 122-1 to 122-3, as in the case of FIG. 10, couple four computational qubit devices 111.

On the other hand, the four-qubit couplers 122-4 to 122-6, as in the case of the two-qubit couplers 121-1 to 121-3 in FIG. 10, each couple a single computational qubit device 111 with a single readout qubit device 112.

The four-qubit couplers 122-7 to 122-13 are unused.

The control unit 210 may be configured not to parametrically excite the unused qubit devices 110.

In the four-qubit coupling of the Josephson parametric oscillators, the pump frequencies of the four Josephson parametric oscillators are configured to satisfy the relationship of Expression (4).

$${ω}_{p , 1} + {ω}_{p , 2} = {ω}_{p , 3} + {ω}_{p , 4} \qquad ( 4 )$$

ω_{p,1}, ω_{p,2}, ω_{p,3}, and ω_{p,4} represent the pump frequencies of the four Josephson parametric oscillators that are four-qubit-coupled.

In the case of a four-qubit-coupling, the pump frequencies ω_{p,1}, ω_{p,2}ω_{p,3}, and ω_{p,4} of the four Josephson parametric oscillators to be coupled are set to distinct values to prevent the occurrence of two-qubit-coupling.

In the example shown in FIG. 11, for example, the four-qubit coupler 122-1 couples the four computational qubit devices 111-1, 111-2, 111-3, and 111-5. The control unit 210 sets the frequencies of the pump signals input to these four computational qubit devices 111 to distinct values, ensuring that the relationship of Expression (4) is satisfied.

On the other hand, in a case where using a four-qubit coupler to two-qubit-couple two Josephson parametric oscillators, the pump frequencies of the two Josephson parametric oscillators are set to be identical. In the example shown in FIG. 11, for example, the control unit 210 sets the frequency of the pump signal input to the computational qubit device 111 and the frequency of the pump signal input to the readout qubit device to the same value, so that the four-qubit coupler 122-4 two-qubit-couples the computational qubit device 111 and the readout qubit device.

It is conceivable that the resonance frequencies of the two qubit devices 110 that are not coupled are sufficiently detuned from those of the two qubit devices 110 that are coupled. For example, the resonance frequency can be adjusted by inputting a direct current to the inductor 320 and changing the magnetic flux passing through the annular structure of the superconducting quantum interference device 310.

The configuration shown in FIG. 11 corresponds to a circuit structure that is an extension of the LHZ scheme. This circuit can embed a fully connected 6-bit logical model, using the LHZ scheme at most. This circuit can be considered an example of applying it to a problem represented by a fully connected 4-bit logical model, where several qubit devices 110 are used as readout qubit devices 112.

Thus, a circuit capable of handling an LHZ model larger than the problem to be solved can be employed, and some of the qubit devices 110, which are not utilized for solution search through quantum annealing, may be used as readout qubit devices 112.

In the example shown in FIG. 11 also, the control unit 210 adiabatically changes the state until it reaches the coherent state, while simultaneously inputting a pump signal to the computational qubit device 111 to induce interactions. After the computational qubit device 111 reaches the coherent state, the control unit 210 inputs a pump signal to the readout qubit device 112, inducing two-qubit interactions with the computational qubit device 111. Then, the observation unit 220 reads out the bit value from the readout qubit device 112.

The circuit structure of the information processing device 100 in the third example embodiment may be any circuit structure in which an LHZ model can be embedded, and is not limited to a specific network structure shape. For example, the information processing device 100 may be configured in the shape of a model based on the LHZ scheme, or may be configured in a square shape.

In the third example embodiment also, the information processing qubit is described as a computational qubit. However, the information processing qubit may also be used for purposes other than computation.

As described above, the information processing device 100 is configured with a circuit including a plurality of the qubit devices 110 on which an LHZ model, which is a model based on the LHZ scheme, is implemented, and four-qubit couplers 122 that are the couplers 120, in a circuit having a larger number of bits in a logical model than a problem that is a target of quantum computing. The control unit 210 controls the information processing device 100 so that: one or more of the qubit devices 110 are operated as the computational qubit devices 111; one or more of the qubit devices 110 other than the computational qubit devices 111 are operated as the readout qubit devices 112; and one of the readout qubit devices 112 and one of the computational qubit devices 111 are two-qubit-coupled for each of the four-qubit couplers 122 coupling the readout qubit devices 112 with other qubit devices 110.

According to the information processing device 100, the readout qubit device 112 can be provided in the information processing device 100, which implements a physical model obtained by converting a logical model using the LHZ scheme, without the necessity of separately adding a qubit device 110 to be used as the readout qubit device 112. Thus, in the information processing device 100, it is expected that the bit value can be read out with relatively high accuracy from the LHZ scheme model. In this respect, it is expected that the information processing device 100 will be able to calculate with higher accuracy a solution to a problem represented by a fully connected logical model.

### Fourth Example Embodiment

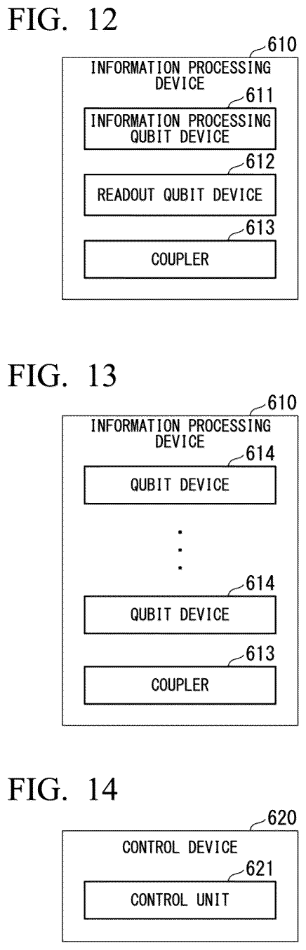

FIG. 12 is a diagram showing a configuration example of the information processing device according to at least one of the example embodiments. In the configuration shown in FIG. 12, an information processing device 610 includes an information processing qubit device 611, a readout qubit device 612, and a coupler 613.

With such a configuration, the coupler 613 couples the information processing qubit device 611 and the readout qubit device 612. The readout qubit device 612 is coupled by the coupler 613 to the information processing qubit device 611 so as to assume the same bit value as the information processing qubit device 611.

In the information processing device 610, the control of the readout qubit device 612 does not need to be the same as that for an information processing qubit device 611. In this respect, the information processing device 610 has a relatively higher degree of freedom in controlling the readout qubit device 612. As a result, it is expected that the information processing device 610 will be able to control the readout qubit device 612 in a manner more suitable for reading out bit values, thereby making it possible to read out bit values with higher accuracy.

FIG. 13 is a diagram showing an example of a configuration of the information processing device 610, where information processing qubit devices 611 and readout qubit devices 612 are denoted as qubit devices 614, explicitly exemplifying that the information processing device 610 includes multiple qubit devices 614.

The information processing device 610 includes, as qubit devices 614, one or more information processing qubit devices and one or more readout qubit devices. The information processing qubit devices may be used as computational qubit devices.

### Fifth Example Embodiment

FIG. 14 is a diagram showing a configuration example of the control device according to at least one of the example embodiments. In the configuration shown in FIG. 14, a control device 620 includes a control unit 621.

With such a configuration, the control unit 621 controls the information processing device including an information processing qubit device and a readout qubit device, and a coupler that couples the information processing qubit device and the readout qubit device, so that the readout qubit device is coupled by the coupler to the information processing qubit device so as to assume the same bit value as the information processing qubit device.

The control unit 621 serves as an example of the control means.

According to the control device 620, the control of the readout qubit device does not need to be the same as that for an information processing qubit device, and the degree of freedom for controlling the readout qubit device is relatively high. As a result, it is expected that the control device 620 will be able to control the readout qubit device in a manner more suitable for reading out bit values, thereby making it possible to read out bit values with higher accuracy.

### Sixth Example Embodiment

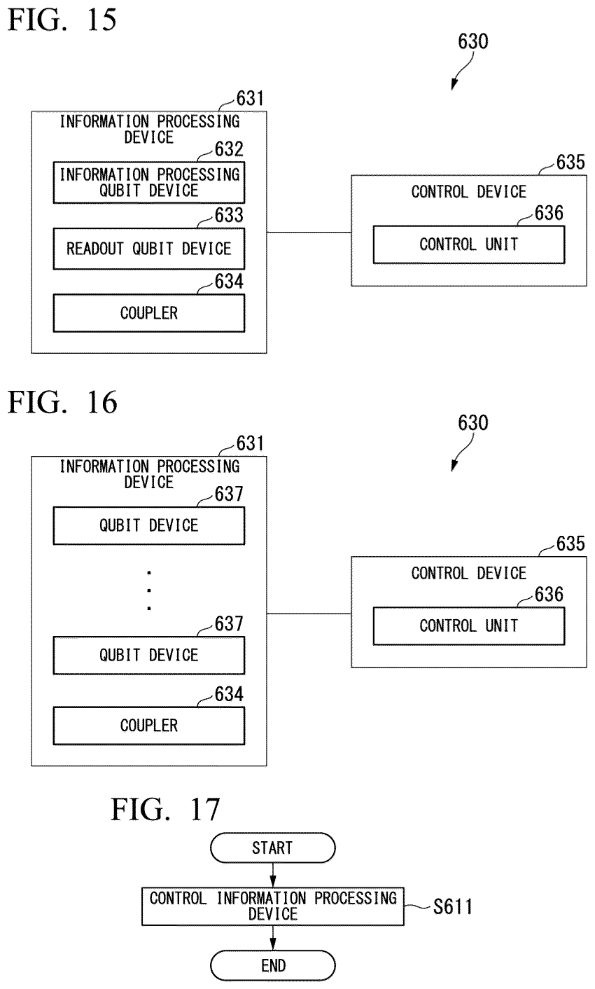

FIG. 15 is a diagram showing a configuration example of an information processing system according to at least one of example embodiments. In the configuration shown in FIG. 15, an information processing system 630 includes an information processing device 631 and a control device 635. The information processing device 631 includes an information processing qubit device 632, a readout qubit device 633, and a coupler 634. The control device 635 includes a control unit 636.

With such a configuration, the coupler 634 couples the information processing qubit device 632 and the readout qubit device 633. The control unit 636 controls the information processing device 631 so that the readout qubit device 633 is coupled by the coupler 634 to the information processing qubit device 632 so as to assume the same bit value as the information processing qubit device 632.

The control unit 636 serves as an example of the control means.

In the information processing system 630, the control unit 636 does not need to control the readout qubit device 633 in the same manner as the information processing qubit device 632. In this respect, the information processing system 630 has a relatively higher degree of freedom in controlling the readout qubit device 633. As a result, in the information processing system 630, it is expected to be able to control the readout qubit device 633 in a manner more suitable for reading out bit values, thereby making it possible to read out bit values with higher accuracy.

FIG. 16 is a diagram showing an example of a configuration of the information processing system 630, where information processing qubit devices 632 and readout qubit devices 633 are denoted as qubit devices 637, explicitly exemplifying that the information processing device 631 includes multiple qubit devices 637.

The information processing device 631 includes, as qubit devices 637, one or more information processing qubit devices and one or more readout qubit devices. The information processing qubit devices may be used as computational qubit devices.

### Seventh Example Embodiment

FIG. 17 is a diagram showing an example of a processing procedure in a control method according to at least one of the example embodiments. The control method shown in FIG. 17 includes a step of controlling an information processing device (Step S611).

In the step of controlling an information processing device (Step S611), a control device that controls an information processing device including an information processing qubit device and a readout qubit device, and a coupler that couples the information processing qubit device and the readout qubit device, controls the information processing device, so that the readout qubit device is coupled by the coupler to the information processing qubit device so as to assume the same bit value as the information processing qubit device.

According to the control method shown in FIG. 17, the control of the readout qubit device does not need to be the same as that for an information processing qubit device, and the degree of freedom for controlling the readout qubit device is relatively high. As a result, it is expected in the control method shown in FIG. 17 that it will be able to control the readout qubit device in a manner more suitable for reading out bit values, thereby making it possible to read out bit values with higher accuracy.

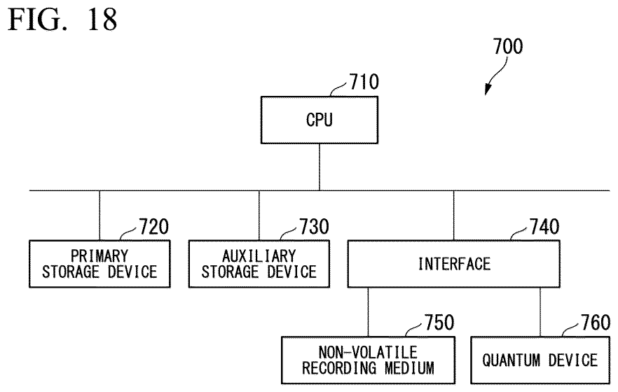

FIG. 18 is a diagram showing a configuration example of a computer according to at least one of the example embodiments. In the configuration shown in FIG. 18, a computer 700 includes a CPU 710, a primary storage device 720, an auxiliary storage device 730, an interface 740, and a non-volatile recording medium 750. Also, the computer 700 is connected to a quantum device 760 for communication. For example, as in the example of FIG. 4, the computer 700 may be connected to the quantum device 760 for communication via a control unit that converts a control signal from the computer 700 into an analog control signal and transmits it to the quantum device 760, and an observation unit that converts the analog signal from the quantum device 760 into a digital signal.

The quantum device 760 may be configured as part of the computer 700. Alternatively, the quantum device 760 may be a component external to the computer 700.

One or more of the control device 200, the control device 620, and the control device 635 mentioned above or part thereof may be implemented in the computer 700. In such a case, operations of the respective processing units described above are stored in the auxiliary storage device 730 in the form of a program. The CPU 710 reads out the program from the auxiliary storage device 730, loads it on the primary storage device 720, and executes the processing described above according to the program. Moreover, the CPU 710 secures, according to the program, memory storage regions corresponding to the respective storage units mentioned above, in the primary storage device 720. Communication between each device and other devices is executed by the interface 740 having a communication function and communicating under the control of the CPU 710. The interface 740 also has a port for the non-volatile recording medium 750, and reads information from the non-volatile recording medium 750 and writes information to the non-volatile recording medium 750.

The quantum device 760 is a device (circuit) that operates using a quantum state in quantum mechanics. The quantum device 760 operates as described above in each example embodiment for quantum computing, such as quantum annealing.

In the case where the control device 200 is implemented in the computer 700, operations of the processing unit 235 and each component thereof are stored in the form of a program in the auxiliary storage device 730. The CPU 710 reads out the programs from the auxiliary storage device 730, loads them on the primary storage device 720, and executes the processes described above, according to the programs.

Also, the CPU 710 secures a memory storage region in the primary storage device 720 for the storage unit 234, according to the program. Communication with other devices performed by the communication unit 231 is executed by the interface 740 having a communication function and operating under the control of the CPU 710. Display of images performed by the display unit 232 is executed by the interface 740 having a display device and displaying various images under the control of the CPU 710. User operations are accepted through the operation input unit 233 by the interface 740 having an input device and accepting user operations under control of the CPU 710.

In the case where the control device 620 is implemented in the computer 700, operations of the control unit 621 are stored in the auxiliary memory storage device 730 in the form of a program. The CPU 710 reads out the programs from the auxiliary storage device 730, loads them on the primary storage device 720, and executes the processes described above, according to the programs.

Moreover, the CPU 710 secures a memory storage region in the primary storage device 720 for the processing to be performed by the control device 620, according to the program. Communication with other devices performed by the control device 620 is executed by the interface 740 having a communication function and operating under the control of the CPU 710. Interaction between the control device 620 and the user is executed by the interface 740 having an input device and an output device, presenting information to the user through the output device under the control of the CPU 710, and accepting user operations through the input device.

In the case where the control device 635 is implemented in the computer 700, operations of the control unit 636 are stored in the auxiliary memory storage device 730 in the form of a program. The CPU 710 reads out the programs from the auxiliary storage device 730, loads them on the primary storage device 720, and executes the processes described above, according to the programs.

Moreover, the CPU 710 secures a memory storage region in the primary storage device 720 for the processing to be performed by the control device 635, according to the program. Communication with other devices performed by the control device 635 is executed by the interface 740 having a communication function and operating under the control of the CPU 710. Interaction between the control device 635 and the user is executed by the interface 740 having an input device and an output device, presenting information to the user through the output device under the control of the CPU 710, and accepting user operations through the input device.

Any one or more of the programs described above may be recorded in the non-volatile recording medium 750. In such a case, the interface 740 may read the program from the non-volatile recording medium 750. Then, the CPU 710 directly executes the program read by the interface 740, or it may be temporarily stored in the primary storage device 720 or the auxiliary storage device 730 and then executed.

It should be noted that a program for executing some or all of the processes performed by the control device 200, the control device 620, and the control device 635 may be recorded on a computer-readable recording medium, and the program recorded on the recording medium may be read into and executed on a computer system, to thereby perform the processing of each unit. The “computer system” here includes an OS (operating system) and hardware such as peripheral devices.

Moreover, the “computer-readable recording medium” referred to here refers to a portable medium such as a flexible disk, a magnetic optical disk, a ROM (Read Only Memory), and a CD-ROM (Compact Disc Read Only Memory), or a storage device such as a hard disk built into a computer system. The above program may be a program for realizing a part of the functions described above, and may be a program capable of realizing the functions described above in combination with a program already recorded in a computer system.

The example embodiments have been described in detail. However, the specific configuration of the disclosure is not limited to the example embodiments, and may include designs and so forth that do not depart from the scope of the present disclosure. Moreover, the example embodiments described above may be combined with another example embodiment where appropriate. In the above example embodiment, the superconducting quantum interference device has been described with respect to an example in which the number of Josephson junctions is two. However, the number of Josephson junctions may be three or more.

According to the present disclosure, it is possible to enable a relatively higher degree of freedom of control over for a qubit device whose bit value is to be read out.

While preferred example embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

A part or all of the example embodiments described above can be written as in the supplementary notes below, but is not limited thereto.

### (Supplementary Note 1)

An information processing device comprising:
an information processing qubit device and a readout qubit device, each configured with a Josephson parametric oscillator; and
a coupler that couples the information processing qubit device and the readout qubit device.
wherein the readout qubit device is coupled by the coupler to the information processing qubit device so as to assume the same bit value as the information processing qubit device.

### (Supplementary Note 2)

The information processing device according to supplementary note 1, wherein the information processing qubit device is a computational qubit device.

### (Supplementary Note 3)

The information processing device according to supplementary note 2, wherein of the readout qubit device and the computational qubit device coupled to each other, the readout qubit device has a nonlinearity lower than that of the computational qubit device.

### (Supplementary Note 4)

The information processing device according to supplementary note 2 or 3, wherein the readout qubit device and the computational qubit device coupled to each other are excited at the same frequency.

### (Supplementary Note 5)

The information processing device according to any one of supplementary notes 2 to 4, wherein a pump frequency of the computational qubit device is higher than twice a resonance frequency of the computational qubit device, and
a pump frequency of the readout qubit device is lower than twice a resonance frequency of the readout qubit device.

### (Supplementary Note 6)

The information processing device according to supplementary note 2 or 3, wherein the readout qubit device and the computational qubit device coupled to each other are excited at the same pump frequency,
a resonance frequency of the computational qubit device is lower than one-half the pump frequency, and
a resonance frequency of the readout qubit device is higher than one-half the pump frequency.

### (Supplementary Note 7)

The information processing device according to any one of supplementary notes 2 to 6, wherein the readout qubit device is excited after the computational qubit device reaches a coherent state.

### (Supplementary Note 8)

The information processing device according to any one of supplementary notes 2 to 7, wherein the computational qubit device and one or more four-qubit couplers among the couplers form an LHZ scheme model.

### (Supplementary Note 9)

A control device comprising
a control means that controls an information processing device including an information processing qubit device and a readout qubit device, each configured with a Josephson parametric oscillator, and a coupler that couples the information processing qubit device and the readout qubit device, so that the readout qubit device is coupled by the coupler to the information processing qubit device so as to assume the same bit value as the information processing qubit device.

### (Supplementary Note 10)

The control device according to supplementary note 9, wherein the information processing qubit device is a computational qubit device.

### (Supplementary Note 11)

The control device according to supplementary note 10, wherein of the readout qubit device and the computational qubit device coupled to each other, the readout qubit device has a nonlinearity lower than that of the computational qubit device.

### (Supplementary Note 12)

The control device according to supplementary note 10 or 11, wherein the control means excites the readout qubit device and the computational qubit device coupled to each other at the same frequency.

### (Supplementary Note 13)

The control device according to any one of supplementary notes 10 to 12, wherein the control means controls the information processing device so that a pump frequency of the computational qubit device is of a value higher than twice a resonance frequency of the computational qubit device, and a pump frequency of the readout qubit device is of a value lower than twice a resonance frequency of the readout qubit device.

### (Supplementary Note 14)

The control device according to supplementary note 10 or 11, wherein the control means controls the information processing device so that the readout qubit device and the computational qubit device coupled to each other are excited at the same pump frequency, a resonance frequency of the computational qubit device is lower than one-half the pump frequency, and a resonance frequency of the readout qubit device is higher than one-half the pump frequency.

### (Supplementary Note 15)

The control device according to any one of supplementary notes 10 to 14, wherein the control means excites the readout qubit device after the computational qubit device reaches a coherent state.

### (Supplementary Note 16)

The control device according to any one of supplementary notes 10 to 15, wherein the control means controls the information processing device in which the computational qubit device and one or more four-qubit couplers among the couplers form an LHZ scheme model.

### (Supplementary Note 17)

The control device according to any one of supplementary notes 10 to 16, wherein the information processing device is configured with a circuit including a plurality of the qubit devices on which an LHZ model, which is a model based on the LHZ scheme, is implemented, and four-qubit couplers that are the couplers, in a circuit having a larger number of bits in a logical model than a problem that is a target of quantum computing, and
the control means controls the information processing device so that one or more of the qubit devices are operated as the computational qubit devices, one or more of the qubit devices other than the computational qubit devices are operated as the readout qubit devices, and one of the readout qubit devices and one of the computational qubit devices are two-qubit-coupled for each of the four-qubit couplers coupling the readout qubit devices with other qubit devices.

### (Supplementary Note 18)

An information processing system comprising:
an information processing device; and
a control device
wherein the information processing device includes:
an information processing qubit device and a readout qubit device, each configured with a Josephson parametric oscillator; and
a coupler that couples the information processing qubit device and the readout qubit device,
wherein the control device includes a control means that controls the information processing device so that the readout qubit device is coupled by the coupler to the information processing qubit device so as to assume the same bit value as the information processing qubit device.

### (Supplementary Note 19)

The information processing system according to supplementary note 18, wherein the information processing qubit device is a computational qubit device.

### (Supplementary Note 20)

The information processing system according to supplementary note 19, wherein of the readout qubit device and the computational qubit device coupled to each other, the readout qubit device has a nonlinearity lower than that of the computational qubit device.

### (Supplementary Note 21)

The information processing system according to supplementary note 19 or 20, wherein the control means excites the readout qubit device and the computational qubit device coupled to each other at the same frequency.

### (Supplementary Note 22)

The information processing system according to any one of supplementary notes 19 to 21, wherein the control means controls the information processing device so that a pump frequency of the computational qubit device is of a value higher than twice a resonance frequency of the computational qubit device, and a pump frequency of the readout qubit device is of a value lower than twice a resonance frequency of the readout qubit device.

### (Supplementary Note 23)

The information processing system according to supplementary note 19 or 20, wherein the control means controls the information processing device so that the readout qubit device and the computational qubit device coupled to each other are excited at the same pump frequency, a resonance frequency of the computational qubit device is lower than one-half the pump frequency, and a resonance frequency of the readout qubit device is higher than one-half the pump frequency.

### (Supplementary Note 24)

The information processing system according to any one of supplementary notes 19 to 23, wherein the control means excites the readout qubit device after the computational qubit device reaches a coherent state.

### (Supplementary Note 25)

The information processing system according to any one of supplementary notes 19 to 24, wherein the control means controls the information processing device in which the computational qubit device and one or more four-qubit couplers among the couplers form an LHZ scheme model.

### (Supplementary Note 26)

The information processing system according to any one of supplementary notes 19 to 25, wherein the information processing device is configured with a circuit including a plurality of the qubit devices on which an LHZ model, which is a model based on the LHZ scheme, is implemented, and four-qubit couplers that are the couplers, in a circuit having a larger number of bits in a logical model than a problem that is a target of quantum computing, and
the control means controls the information processing device so that one or more of the qubit devices are operated as the computational qubit devices, one or more of the qubit devices other than the computational qubit devices are operated as the readout qubit devices, and one of the readout qubit devices and one of the computational qubit devices are two-qubit-coupled for each of the four-qubit couplers coupling the readout qubit devices with other qubit devices.

### (Supplementary Note 27)

A control method comprising a step, performed by
a control device that controls an information processing device comprising an information processing qubit device and a readout qubit device, each configured with a Josephson parametric oscillator, and a coupler that couples the information processing qubit device and the readout qubit device, of
controlling the information processing device so that the readout qubit device is coupled by the coupler to the information processing qubit device so as to assume the same bit value as the information processing qubit device.

### (Supplementary Note 28)

The control method according to supplementary note 27, wherein the information processing qubit device is a computational qubit device.

### (Supplementary Note 29)

The control method according to supplementary note 28, wherein of the readout qubit device and the computational qubit device coupled to each other, the readout qubit device has a nonlinearity lower than that of the computational qubit device.

### (Supplementary Note 30)

The control method according to supplementary note 28 or 29, wherein the step of controlling the information processing device includes a step of exciting the readout qubit device and the computational qubit device coupled to each other at the same frequency.

### (Supplementary Note 31)

The control method according to any one of supplementary notes 28 to 30, wherein the step of controlling the information processing device includes a step of controlling the information processing device so that a pump frequency of the computational qubit device is of a value higher than twice a resonance frequency of the computational qubit device, and a pump frequency of the readout qubit device is of a value lower than twice a resonance frequency of the readout qubit device.

### (Supplementary Note 32)

The control method according to supplementary note 28 or 29, wherein the step of controlling the information processing device includes a step of controlling the information processing device so that the readout qubit device and the computational qubit device coupled to each other are excited at the same pump frequency, a resonance frequency of the computational qubit device is lower than one-half the pump frequency, and a resonance frequency of the readout qubit device is higher than one-half the pump frequency.

### (Supplementary Note 33)

The control method according to any one of supplementary notes 28 to 32, wherein the step of controlling the information processing device includes a step of exciting the readout qubit device after the computational qubit device reaches a coherent state.

### (Supplementary Note 34)

The control method according to any one of supplementary notes 28 to 33, wherein the step of controlling the information processing device includes a step of controlling the information processing device in which the computational qubit device and one or more four-qubit couplers among the couplers form an LHZ scheme model.

### (Supplementary Note 35)

The control method according to any one of supplementary notes 28 to 34, wherein the information processing device is configured with a circuit including a plurality of the qubit devices on which an LHZ model, which is a model based on the LHZ scheme, is implemented, and four-qubit couplers that are the couplers, in a circuit having a larger number of bits in a logical model than a problem that is a target of quantum computing, and
the step of controlling the information processing device includes a step of controlling the information processing device so that one or more of the qubit devices are operated as the computational qubit devices, one or more of the qubit devices other than the computational qubit devices are operated as the readout qubit devices, and one of the readout qubit devices and one of the computational qubit devices are two-qubit-coupled for each of the four-qubit couplers coupling the readout qubit devices with other qubit devices.

### (Supplementary Note 36)

A program that causes
a computer that controls an information processing device including an information processing qubit device and a readout qubit device, each configured with a Josephson parametric oscillator, and a coupler that couples the information processing qubit device and the readout qubit device, to execute a step of
controlling the information processing device so that the readout qubit device is coupled by the coupler to the information processing qubit device so as to assume the same bit value as the information processing qubit device.

### (Supplementary Note 37)

The program according to supplementary note 36, wherein the information processing qubit device is a computational qubit device.

### (Supplementary Note 38)

The program according to supplementary note 37, wherein of the readout qubit device and the computational qubit device coupled to each other, the readout qubit device has a nonlinearity lower than that of the computational qubit device.

### (Supplementary Note 39)

The program according to supplementary note 37 or 38, wherein the step of controlling the information processing device includes a step of causing the computer to excite the readout qubit device and the computational qubit device coupled to each other at the same frequency.

### (Supplementary Note 40)

The program according to any one of supplementary notes 37 to 39, wherein the step of controlling the information processing device includes a step of causing the computer to execute control of the information processing device so that a pump frequency of the computational qubit device is of a value higher than twice a resonance frequency of the computational qubit device, and a pump frequency of the readout qubit device is of a value lower than twice a resonance frequency of the readout qubit device.

### (Supplementary Note 41)

The program according to supplementary note 37 or 38, wherein the step of controlling the information processing device includes a step of causing the computer to execute control of the information processing device so that the readout qubit device and the computational qubit device coupled to each other are excited at the same pump frequency, a resonance frequency of the computational qubit device is lower than one-half the pump frequency, and a resonance frequency of the readout qubit device is higher than one-half the pump frequency.

### (Supplementary Note 42)

The program according to any one of supplementary notes 37 to 41, wherein the step of controlling the information processing device includes a step of causing the computer to execute excitation of the readout qubit device after the computational qubit device reaches a coherent state.

### (Supplementary Note 43)

The program according to any one of supplementary notes 37 to 42, wherein the step of controlling the information processing device includes a step of causing the computer to execute control of the information processing device in which the computational qubit device and one or more four-qubit couplers among the couplers form an LHZ scheme model.

### (Supplementary Note 44)

The program according to any one of supplementary notes 37 to 43, wherein the information processing device is configured with a circuit including a plurality of the qubit devices on which an LHZ model, which is a model based on the LHZ scheme, is implemented, and four-qubit couplers that are the couplers, in a circuit having a larger number of bits in a logical model than a problem that is a target of quantum computing, and
the step of controlling the information processing device includes a step of causing the computer to execute control of the information processing device so that one or more of the qubit devices are operated as the computational qubit devices, one or more of the qubit devices other than the computational qubit devices are operated as the readout qubit devices, and one of the readout qubit devices and one of the computational qubit devices are two-qubit-coupled for each of the four-qubit couplers coupling the readout qubit devices with other qubit devices.

What is claimed is:

1. An information processing device comprising:
a first Josephson parametric oscillator used as an information processing qubit element;
a second Josephson parametric oscillator used as a readout qubit element, each configured with a Josephson parametric oscillator; and
a coupler coupling the information processing qubit element and the readout qubit element,
wherein a bit value indicated by the readout qubit element is same as a bit value indicated by the information processing qubit element.

2. The information processing device according to claim 1, wherein the information processing qubit element is a computational qubit element.

3. The information processing device according to claim 2, wherein of the readout qubit element and the computational qubit element coupled to each other, a nonlinearity of the readout qubit element is lower than a nonlinearity of the computational qubit element.

4. The information processing device according to claim 2, wherein
the readout qubit element and the computational qubit element coupled to each other are excited at a same frequency.

5. The information processing device according to claim 2, wherein a pump frequency of the computational qubit element is higher than twice a resonance frequency of the computational qubit element, and
wherein a pump frequency of the readout qubit element is less than twice a resonance frequency of the readout qubit element.

6. The information processing device according to claim 2, wherein the readout qubit element and the computational qubit element coupled to each other are excited at a same pump frequency,
wherein the pump frequency is higher than twice a resonance frequency of the computational qubit element, and
wherein the pump frequency is less than twice a resonance frequency of the readout qubit element.

7. The information processing device according to claim 2, wherein the readout qubit element is excited after the computational qubit element reaches a coherent state.

8. The information processing device according to claim 2, wherein the computational qubit element and one or more four-qubit couplers among the couplers form a Lechner-Hauke-Zoller (LHZ) scheme model.

9. A control device comprising
a controller configured to control an information processing element including a first Josephson parametric oscillator used as an information processing qubit element, a second Josephson parametric oscillator used as a readout qubit element, and a coupler coupling the information processing qubit element and the readout qubit element,
wherein the controller controls the readout qubit element and the information processing qubit element so that a bit value indicated by the readout qubit device is same as a bit value indicated by the information processing qubit element.

10. A control method executed by a control device for controlling an information processing device including a first Josephson parametric oscillator used as an information processing qubit element, a second Josephson parametric oscillator used as a readout qubit element, and a coupler coupling the information processing qubit element and the readout qubit element, the method comprising
controlling the readout qubit element and the information processing element so that a bit value indicated by the readout qubit element is same as a bit value indicated by the information processing qubit element.

11. The control method according to claim 10, wherein the information processing qubit element is a computational qubit element.

12. The control method according to claim 11, wherein of the readout qubit element and the computational qubit element coupled to each other, a nonlinearity of the readout qubit element is lower than a nonlinearity of the computational qubit element.

13. The control method according to claim 11, further comprising exciting the readout qubit element and the computational qubit element coupled to each other at a same frequency.

14. The control method according to claim 11, wherein a pump frequency of the computational qubit element is higher than twice a resonance frequency of the computational qubit element, and
wherein a pump frequency of the readout qubit element is less than twice a resonance frequency of the readout qubit element.

15. The control method according to claim 11, further comprising exciting the readout qubit element and the computational qubit element coupled to each other at a same pump frequency,
wherein the pump frequency is higher than twice a resonance frequency of the computational qubit element, and
wherein the pump frequency is less than twice a resonance frequency of the readout qubit element.

16. The control method according to claim 11, further comprising exciting the readout qubit element after the computational qubit element reaches a coherent state.

17. The control method according to claim 11, wherein the computational qubit element and one or more four-qubit couplers among the couplers form a Lechner-Hauke-Zoller (LHZ) scheme model.
